(19) United States
(12) Patent Application Publication
(10) Pub. No.: US 2021/0247199 A1
(43) Pub. Date: Aug. 12, 2021

(54) AUTONOMOUS NAVIGATION SYSTEMS FOR TEMPORARY ZONES

(71) Applicant: 3M INNOVATIVE PROPERTIES COMPANY, St. Paul, MN (US)

(72) Inventors: Justin M. Johnson, Hudson, WI (US); James W. Howard, North Oaks, MN (US); James B. Snyder, Minneapolis, MN (US); Travis L. Potts, Woodbury, MN (US); Kenneth L. Smith, White Bear Lake, MN (US); Tamara M. Meehan Russell, Woodbury, MN (US)

(21) Appl. No.: 17/053,854

(22) PCT Filed: Apr. 22, 2019
(86) PCT No.: PCT/IB2019/053313

§ 371 Date: Nov. 9, 2020

Related U.S. Application Data
(60) Provisional application No. 62/671,255, filed on May 14, 2018.

(51) Int. Cl. G01C 21/34; G06K 9/00; B60W 60/00; B60W 50/14; G01C 21/36; B60W 40/06; G06N 3/04

(52) U.S. Cl. CPC G01C 21/3453; G06K 9/00798; B60W 60/001; B60W 50/14; B60W 2420/52; B60W 40/06; G06N 3/04; B60W 2420/42; B60W 2552/53; G01C 21/3602

(57) ABSTRACT

Example systems disclosed herein include a pathway-article assisted vehicle (PAAV) that utilizes an autonomous navigation system for navigating temporary zones on vehicle pathways. The PAAV includes at least image capture device and a computing device. The image capture device generates an image that includes an indication of a temporary zone on a vehicle pathway, such as a pathway article proximate to the vehicle pathway that indicates the temporary zone. The computing device processes the image to obtain the indication of the temporary zone from the image, such as a code on the pathway article, and modifies, based on the indication of the temporary zone, a mode of autonomous operation of the PAAV while operating within the temporary zone on the vehicle pathway.

### TECHNICAL FIELD

The present application relates generally to pathway articles and systems in which such pathway articles may be used.

### BACKGROUND

Current and next generation vehicles are increasingly including fully automated guidance system vehicles, semi-automated guidance system vehicles, and fully manual vehicles. Semi-automated vehicles may include those with advanced driver assistance systems (ADAS) that may be designed to assist drivers avoid accidents. Automated and semi-automated vehicles may include adaptive features that may automate lighting, provide adaptive cruise control, automate braking, incorporate GPS/traffic warnings, connect to smartphones, alert driver to other cars or dangers, keep the driver in the correct lane, show what is in blind spots and other features. Infrastructure may increasingly become more intelligent by including systems to help vehicles move more safely and efficiently such as installing sensors, communication devices and other systems. Over the next several decades, vehicles of all types—manual, semi-automated and automated—may operate on the same roads and may need to operate cooperatively and synchronously for safety and efficiency.

While adaptive features of automated and semi-automated vehicles may operate well under ordinary circumstances, they may not be able to navigate temporary changes to road infrastructure. For example, rules that apply in a construction-free section of a road or a street, such as navigation within lane boundaries, may not apply during construction in that section.

### SUMMARY

In general, this disclosure describes techniques by which autonomous vehicle navigation systems are dynamically and automatically modified to adapt to atypical navigational environments, such as a temporary work zone along a road. Example autonomous vehicle navigation systems are described that capture and extract information encoded within one or more road signs proximate the temporary work zone and modify the operational rules of the vehicle to adapt autonomous navigation of the temporary zone. As examples, the temporary zone may include a construction zone, an alternate route, or other temporary section of road in which the semantics of road infrastructure (e.g., signs and pathway markings) are temporarily overridden with modified operational requirements for vehicles operating in the temporary zone. Responsive to the information decoded from the road signs, a navigation system may modify its mode of autonomous vehicle operation according to an associated set of rules for navigating particular navigational characteristics of the temporary zone, such as rules for navigating particular infrastructure changes or markers.

In some examples, a navigation system includes a sensor to detect information regarding the complexity of the temporary zone, such as a classification based on the set of rules for the temporary zone. Autonomous operation of the vehicle may be limited based on the complexity of the temporary zone. For example, a semi-autonomous vehicle may be capable of operating autonomously in a low complexity temporary zone but may not be able to operate in a high complexity temporary zone due to hardware and/or software limitations of the vehicle, ambiguity of a rule set or vehicle path for navigating the temporary zone, and other limitation or condition. Based on the information extracted from the one or more signs regarding the temporary zone, a controller within the autonomous vehicle dynamically modifies a mode of autonomous operation of the autonomous vehicle to handle the complexity of the temporary zone and modifies autonomous operation of the vehicle according to the updated set of rules for the temporary zone. By using information regarding the complexity of the temporary zone, the autonomous navigation systems discussed herein may have a higher level and/or continuity of autonomous operation than autonomous navigation systems that do not use information regarding the complexity of the temporary zone.

In this way, the autonomous navigation systems discussed herein may provide technical advantages for autonomously navigating a temporary zone. For example, an autonomous navigation system that operates according to a set of rules for the particular temporary zone or classification of temporary zone may navigate the temporary zone more accurately and/or safely than autonomous navigation systems that use default rules to autonomously navigate the temporary zone. As another example, due to gradations in the complexity of temporary zones, an autonomous navigation system that operates based on the complexity of a particular temporary zone may operate at an intermediate level of automation that is higher than a level of automation of an autonomous navigation system that does not modify autonomous operation based on the complexity of the temporary zone. As another example, a temporary zone may include markers or other unique indicators that are autonomously navigable by autonomous navigation systems using information regarding the unique indicators, but that are not autonomously navigable by autonomous navigation systems that do not recognize unique indicators of the temporary zone.

In some examples, a system includes a pathway-article assisted vehicle (PAAV). The PAAV includes at least one image capture device and a computing device. The at least one image capture device is configured to generate an image that includes an indication of a temporary zone on a vehicle pathway. The computing device is configured to process the image to obtain the indication of the temporary zone from the image and modify, based on the indication of the temporary zone, a mode of autonomous operation of the PAAV for operation of the PAAV within the temporary zone on the vehicle pathway. In some examples, the system further includes one or more pathway articles proximate to the vehicle pathway that indicate the temporary zone. In some examples, the one or more pathway articles include a code embodied therein, such that the code indicates the temporary zone.

In another example, a computing device includes a memory and one or more computer processors. The one or more processors are configured to receive an image that includes an indication of a temporary zone on a vehicle pathway, process the image to obtain the indication of the temporary zone from the image, and output, based on the indication of the temporary zone and to a pathway-article assisted vehicle (PAAV), a mode of autonomous operation of the PAAV while the PAAV is operating within the temporary zone on the vehicle pathway.

In yet another example, an article includes a physical surface having a code embodied thereon. The code indicates a temporary zone on a vehicle pathway. In some examples, the code is detectable by at least one image capture device mounted within a pathway-article assisted vehicle (PAAV) and the code is encoded to cause a computing device to modify, based on the code, a mode of autonomous operation of the PAAV while operating within the temporary zone on the vehicle pathway.

In yet another example, a computing device includes a memory and one or more computer processors. The one or more processors are configured to receive an image that includes an indication of a temporary zone on a vehicle pathway, process the image to obtain the indication of the temporary zone from the image, and output, based on the indication of the temporary zone and to a pathway-article assisted vehicle (PAAV), information to perform at least one operation of the PAAV within the temporary zone on the vehicle pathway.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system with a pathway article that is configured to be interpreted by a PAAV, in accordance with techniques of this disclosure.

FIG. 2 is a block diagram illustrating an example computing device, in accordance with one or more aspects of the present disclosure.

FIG. 3 is a diagram of an example roadway that may be navigated by a pathway-article assisted vehicle, in accordance with one or more aspects of the present disclosure.

FIG. 4 is a flow diagram illustrating example operation of a computing device for modifying a mode of autonomous operation of a pathway-article assisted vehicle, in accordance with one or more techniques of this disclosure.

FIG. 5 is a flow diagram illustrating example operation of a computing device for modifying a mode of autonomous operation of a pathway-article assisted vehicle, in accordance with one or more techniques of this disclosure.

FIG. 6 is a conceptual diagram of a cross-sectional view of a pathway article in accordance with techniques of this disclosure.

FIGS. 7A and 7B illustrate cross-sectional views of portions of an article message formed on a retroreflective sheet, in accordance with one or more techniques of this disclosure.

### DETAILED DESCRIPTION

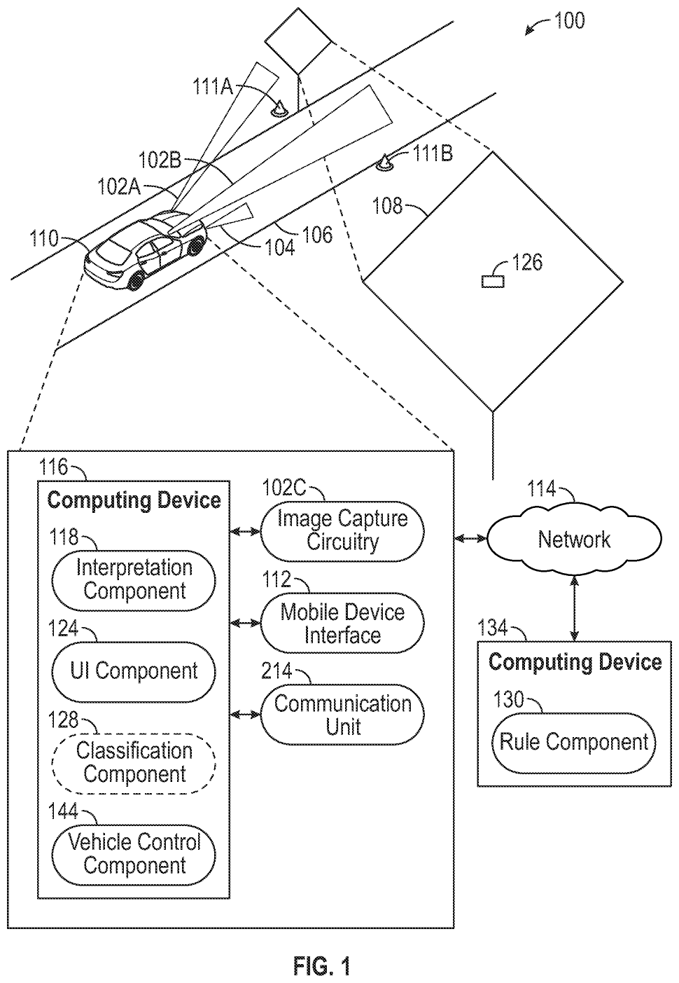

FIG. 1 is a block diagram illustrating an example system 100 with a pathway article 108 that is configured to be interpreted by a PAAV 110, in accordance with techniques of this disclosure. As described herein, PAAV 110 generally refers to a vehicle with a vision system, along with other sensors, that may interpret the vehicle pathway and the vehicle's environment, such as other vehicles or objects. PAAV 110 may interpret information from the vision system and other sensors, make decisions, and take actions to navigate the vehicle pathway. In this disclosure, a vehicle may include any vehicle with or without sensors, such as a vision system, to interpret a vehicle pathway.

As shown in FIG. 1, system 100 includes PAAV 110 that may operate on vehicle pathway 106 and that includes image capture devices 102A and 102B and computing device 116. The illustrated example of system 100 also includes one or more pathway articles 108 having a code 126 embodied thereon as described in this disclosure.

Vehicle pathway 106 may be a road, highway, a warehouse aisle, factory floor, or a pathway not connected to the earth's surface. Vehicle pathway 106 may include portions not limited to the pathway itself. In the example of a road, vehicle pathway 106 may include the road shoulder, physical structures near the pathway such as toll booths, railroad crossing equipment, traffic lights, the sides of a mountain, guardrails, and generally encompassing any other properties or characteristics of the pathway or objects/structures in proximity to the pathway.

Vehicle pathway 106 may include a temporary zone on vehicle pathway 106. The temporary zone may represent a section of vehicle pathway 106 that includes temporary changes to pathway infrastructure. For example, the temporary zone may include a construction zone, a school zone, an event zone, an emergency zone, an alternate route, or other temporary section of road with changes to road infrastructure in which, for instance, the ordinary semantics of the road infrastructure are temporarily overridden, by a governmental or other authority, with modified operational requirements for vehicles operating in the temporary zone. A temporary change to pathway infrastructure may include a variety of lengths of time, including a short period, such as hours, or a longer period, such as a year.

As such, a temporary zone may have navigational characteristics that deviate from ordinary navigational characteristics of vehicle pathway 106. For example, the temporary zone may have navigational characteristics such as a traffic pattern change, worker presence, lane modifications, road surface quality, construction standards changes, or other conditions that are not normally present on or near vehicle pathway 106. The navigational characteristics of the temporary zone may have associated operating rules for safely navigating the temporary zone that deviate from ordinary operating rules of vehicle pathway 106. For example, a temporary zone that includes a degraded road surface quality may have an associated lower speed limit, longer braking distance, and/or control system biased more toward traction control than an ordinary road surface. Additionally or alternatively, a particular level of autonomous operation may not be suitable for the temporary zone. For example, a level of autonomous operation that is conditioned on a driver safely assuming operation of the vehicle in the event of an irregular hazard may not be suitable for a temporary zone for which there may be unexpected changes in features that may not allow for a timely and safe assumption of operation. As such, the temporary zone may have associated restrictions on levels of autonomous operation of vehicles.

For example, during normal operation, vehicle pathway 106 may be a relatively low traffic roadway that includes a two-way stop sign at a cross-section of a higher traffic roadway. Due to construction that reroutes traffic along vehicle pathway 106, vehicle pathway 106 may contain a temporary zone—in this example, a detour to a construction zone—that is configured for higher-than-normal road volume along vehicle pathway 106 relative to the higher traffic roadway. As such, the two-way stop of vehicle pathway 106 may be converted to a temporary four-way stop characterized by, for example, covers over the two-way stop signs and flashing red lights facing each direction of the two traffic roadways. Navigational characteristics of the temporary four-way stop may include a superseded two-way stop indication and an overriding four-way stop indication, as well as ordinary navigational characteristics of the roadway such as lane boundaries. As such, to autonomously or semi-autonomously navigate the temporary four-way stop, PAAV 110 may have an ability to recognize the superseded two-way stop indication, recognize the overriding four-way stop indication, and navigate the four-way stop using the four-way stop indication and/or other environmental factors indicative of the four-way stop. Such ability may correspond to, for example, level 4 driving automation (“level of autonomy”) as defined by Society for Automotive Engineers J3016 (“Surface Vehicle Recommended Practice” standard).

A temporary zone, or section leading up to a temporary zone, of pathway 106 may include markers 111A and 111B, collectively referred to as markers 111. Markers 111 may be configured to indicate a feature of the temporary zone of pathway 106. For example, markers 111 may indicate a beginning of the temporary zone of pathway 106, a lateral limit of the temporary zone of pathway 106, or another feature associated with the temporary zone of pathway 106. Markers that may be used include, but are not limited to, cones, barrels, paint, and the like. In some examples, markers 111 may include machine-readable identifiers that indicate the feature of the temporary zone. For example, markers 111 may include a code or pattern that corresponds to a programmable action for PAAV 110. As an example, a cone may include a pattern that is configured to indicate a rightmost road edge to a PAAV travelling in a southbound direction and a leftmost road edge to a PAAV travelling in a northbound direction. Such markers 111 may provide guidance to PAAV 110 in temporary zones for dynamic and/or temporary traffic control.

PAAV 110 of system 100 may be an autonomous or semi-autonomous vehicle, such as an ADAS, that takes cues from vehicle pathway 106 using vision systems or other sensors. In some examples, PAAV 110 may include occupants that may take full or partial control of PAAV 110. PAAV 110 may be any type of vehicle designed to carry passengers or freight including small electric powered vehicles, large trucks or lorries with trailers, vehicles designed to carry crushed ore within an underground mine, or similar types of vehicles. PAAV 110 may include lighting, such as headlights in the visible light spectrum as well as light sources in other spectrums, such as infrared. Some examples of PAAVs may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. PAAV 110 may use various sensors to perceive the environment, infrastructure, and other objects around the vehicle. PAAV 110 may include other sensors such as radar, sonar, lidar, GPS and communication links for the purpose of sensing the vehicle pathway, other vehicles in the vicinity, environmental conditions around the vehicle and communicating with infrastructure. For example, a rain sensor may operate the vehicles windshield wipers automatically in response to the amount of precipitation, and may also provide inputs to the onboard computing device 116. These various sensors combined with onboard computer processing may allow the automated system to perceive complex information and respond to it more quickly than a human driver, as will be explained further below.

As shown in FIG. 1, PAAV 110 of system 100 may include image capture devices 102A and 102B, collectively referred to as image capture devices 102. Image capture devices 102 may convert light or electromagnetic radiation sensed by one or more image capture sensors into information, such as digital image or bitmap comprising a set of pixels. Each pixel may have chrominance and/or luminance components that represent the intensity and/or color of light or electromagnetic radiation. In general, image capture devices 102 may be used to gather information about pathway 106. Image capture devices 102 may send image capture information to computing device 116 via image capture circuitry 102C. Image capture devices 102 may capture lane markings, centerline markings, edge of roadway or shoulder markings, as well as the general shape of the vehicle pathway. The general shape of a vehicle pathway may include turns, curves, incline, decline, widening, narrowing or other characteristics. Image capture devices 102 may have a fixed field of view or may have an adjustable field of view. An image capture device with an adjustable field of view may be configured to pan left and right, up and down relative to PAAV 110 as well as be able to widen or narrow focus. In some examples, image capture devices 102 may include a first lens and a second lens. PAAV 110 may have more or fewer image capture devices 102 in various examples.

Image capture devices 102 may include one or more image capture sensors and one or more light sources. In some examples, image capture devices 102 may include image capture sensors and light sources in a single integrated device. In other examples, image capture sensors or light sources may be separate from or otherwise not integrated in image capture devices 102. As described above, PAAV 110 may include light sources separate from image capture devices 102. Examples of image capture sensors within image capture devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, image capture devices 102 includes at least two different sensors for detecting light in two different wavelength spectrums.

In some examples, one or more light sources 104 include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. As shown in FIG. 1, one or more light sources 104 may emit radiation in the near-infrared spectrum.

In some examples, image capture devices 102 captures frames at 50 frames per second (fps). Other examples of frame capture rates include 60, 30 and 25 fps. It should be apparent to a skilled artisan that frame capture rates are dependent on application and different rates may be used, such as, for example, 100 or 200 fps. Factors that affect required frame rate are, for example, size of the field of view (e.g., lower frame rates can be used for larger fields of view, but may limit depth of focus), and vehicle speed (higher speed may require a higher frame rate).

In some examples, image capture devices 102 may include at least more than one channel. The channels may be optical channels. The two optical channels may pass through one lens onto a single sensor. In some examples, image capture devices 102 includes at least one sensor, one lens and one band pass filter per channel. The band pass filter permits the transmission of multiple near infrared wavelengths to be received by the single sensor. The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, an enhanced sign of this disclosure, while suppressing other features (e.g., other objects, sunlight, headlights)); (c) wavelength region (e.g., broadband light in the visible spectrum and used with either color or monochrome sensors); (d) sensor type or characteristics; (e) time exposure; and (f) optical components (e.g., lensing).

In some examples, image capture devices 102A and 102B may include an adjustable focus function. For example, image capture device 102B may have a wide field of focus that captures images along the length of vehicle pathway 106, as shown in the example of FIG. 1. Computing device 116 may control image capture device 102A to shift to one side or the other of vehicle pathway 106 and narrow focus to capture the image of pathway article 108, or other features along vehicle pathway 106. The adjustable focus may be physical, such as adjusting a lens focus, or may be digital, similar to the facial focus function found on desktop conferencing cameras. In the example of FIG. 1, image capture devices 102 may be communicatively coupled to computing device 116 via image capture circuitry 102C. Image capture circuitry 102C may receive image information from the plurality of image capture devices, such as image capture devices 102, perform image processing, such as filtering, amplification, and the like, and send image information to computing device 116.

Other components of PAAV 110 that may communicate with computing device 116 may include image capture circuitry 102C, described above, mobile device interface 112, and communication unit 214. In some examples image capture circuitry 102C, mobile device interface 112, and communication unit 214 may be separate from computing device 116 and in other examples may be a component of computing device 116.

In the example of FIG. 1, pathway 106 includes pathway article 108, which may be proximate to (i.e. in, adjacent, or leading up to) the temporary zone of pathway 106. Pathway article 108 may include a variety of indicators and/or markers. For example, pathway article 108 may include one or more of an optical tag, a road sign, a pavement marker, a radio-frequency identification, a radio-frequency tag, an acoustic surface pattern, and a material configured to provide a RADAR signature to a RADAR system.

Pathway article 108 in FIG. 1 includes code 126. Code 126 may be detectable by at least one image capture device, such as image capture devices 102, mounted within PAAV 110. Code 126 may include, but is not limited to characters, images, and/or any other information that may be printed, formed, or otherwise embodied on pathway article 108. For example, pathway article 108 may have a physical surface having code 126 embodied thereon. In some examples, code 126 may be encoded via a 2-dimensional bar code. For example, the 2-dimensional bar code may be a QR code. Additional examples of physical surfaces having a code 126 embodied thereon are described in further detail below.

In some cases, a value associated with code 126 may be stored to a Radio Frequency IDentification (RFID) device and accessible using an RFID reader of PAAV 110. In some cases, computing device 116 may access the value associated with code 126 using other types of communications, such as Near-field communication (NFC) protocols and signals; RADAR, laser, or infrared-based readers, or other communication type. In some cases, code 126 may not be affixed to a separate pathway article.

Code 126 indicates a temporary zone of vehicle pathway 106, which may be proximate to pathway article 108. As will be described below, code 126 may be configured to cause a computing device to modify a mode of autonomous operation of PAAV 110 while PAAV 110 is operating within the temporary zone on vehicle pathway 106. Code 126 may indicate the temporary zone by providing, directly or indirectly (e.g., via a link to a database), information related to navigation of the temporary zone. In some examples, code 126 may include a plurality of components or features that provide information related to navigation of the temporary zone.

As will be described further below, code 126 may indicate a variety of types of information. In some examples, code 126 may provide computing device 116 with static information related to the temporary zone. Static information may include any information that is related to navigation of the temporary zone, associated with code 126, and not subject to change. For example, certain features of temporary zones may be standardized and/or commonly used in various temporary zones, such that code 126 may correspond to a pre-defined classification or operating characteristic of the temporary zone. As some examples, code 126 may indicate a beginning of the temporary zone, a navigational characteristic or feature of the temporary zone, a threshold level of autonomous operation of the temporary zone, an operating rule or set of operating rules of the temporary zone, or the like.

In some examples, code 126 may provide computing device 116 with dynamic information related to the temporary zone. Dynamic information may include any information that is related to navigation of the temporary zone, associated with code 126, and subject to change. For example, certain features of temporary zones may be unique to the temporary zone or may change frequently, such that code 126 may correspond to a classification or operating characteristic that is subject to change based on the changing features and updated based on the changing features. In some examples, code 126 may indicate a link to an external computing device, such as computing device 134, that maintains real-time information regarding current classifications or operating characteristics of the temporary zone.

In some examples, pathway article 108 includes additional components that convey other types of information, such as one or more security elements. For example, a security element may be any portion of code 126 that is printed, formed, or otherwise embodied on pathway article 108 that facilitates the detection of counterfeit pathway articles. Pathway article 108 may also include additional information that represents navigational characteristics of vehicle pathway 106 that may be printed, or otherwise disposed in locations that do not interfere with the graphical symbols. In some examples, pathway article 108 may include components of code 126 that do not interfere with the graphical symbols by placing the additional machine readable information so it is detectable outside a visible light spectrum. This may have advantages of avoiding interfering with a human operator interpreting pathway article 108, providing additional security. For example, code 126 of an enhanced sign may be formed by different areas that either retroreflect or do not retroreflect light, non-visible components in FIG. 1 may be printed, formed, or otherwise embodied in a pathway article using any light reflecting technique in which information may be determined from non-visible components. For instance, non-visible components may be printed using visibly-opaque, infrared-transparent ink and/or visibly-opaque, infrared-opaque ink. In some examples, non-visible components may be placed on pathway article 108 by employing polarization techniques, such as right circular polarization, left circular polarization or similar techniques.

In some examples, pathway article 108 includes one or more signs having image data embodied thereon, the image data encoded with the code. For example, pathway article 108 may include a physical surface having an optical element embodied thereon, such that the optical element embodies the code indicative of the temporary zone. In some examples, pathway article 108 may further include an article message that includes a human-perceptible representation of pathway information for the vehicle pathway.

In some examples, pathway article 108 may be an enhanced sign that includes a reflective, non-reflective, and/or retroreflective sheeting attached to a base surface of the enhanced sign. The sheeting has a physical surface and may include authentication information, such as the security elements described above. In this example, a reflective, non-reflective, and/or retroreflective sheet may be applied to a base surface using one or more techniques and/or materials including but not limited to: mechanical bonding, thermal bonding, chemical bonding, or any other suitable technique for attaching retroreflective sheet to a base surface. A base surface may include any surface of an object (such as described above, e.g., an aluminum plate) to which the reflective, non-reflective, and/or retroreflective sheet may be attached. An article message may be printed, formed, or otherwise embodied on the sheeting using any one or more of an ink, a dye, a thermal transfer ribbon, a colorant, a pigment, and/or an adhesive coated film. In some examples, content is formed from or includes a multi-layer optical film, a material including an optically active pigment or dye, or an optically active pigment or dye.

Mobile device interface 112 may include a wired or wireless connection to a smartphone, tablet computer, laptop computer or similar device. In some examples, computing device 116 may communicate via mobile device interface 112 for a variety of purposes such as receiving traffic information, address of a desired destination or other purposes. In some examples computing device 116 may communicate to external networks 114, e.g. the cloud, via mobile device interface 112. In other examples, computing device 116 may communicate via communication units 214.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as networks 114. In some examples communication units 214 may transmit and receive messages and information to other vehicles, such as information interpreted from pathway article 108. In some examples, communication units 214 may transmit and/or receive satellite signals on a satellite network such as a Global Positioning System (GPS) network. In some examples, communications units 214 may transmit and/or receive data to a remote computing system, such as computing device 134, through network 114.

In the example of FIG. 1, computing device 116 includes an interpretation component 118, a user interface (UI) component 124, an optional classification component 128, and a vehicle control component 144. Components 118, 124, 128, and 144 may perform operations described herein using software, hardware, firmware, or a mixture of both hardware, software, and firmware residing in and executing on computing device 116 and/or at one or more other remote computing devices. In some examples, components 118, 124, 128, and 144 may be implemented as hardware, software, and/or a combination of hardware and software.

Computing device 116 may execute components 118, 124, 128, and 144 with one or more processors. Computing device 116 may execute any of components 118, 124, 128,144 as or within a virtual machine executing on underlying hardware. Components 118, 124, 128, 144 may be implemented in various ways. For example, any of components 118, 124, 128, 144 may be implemented as a downloadable or pre-installed application or “app.” In another example, any of components 118, 124, 128, 144 may be implemented as part of an operating system of computing device 116. Computing device 116 may include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of PAAV 110. In some examples, UI component 124 includes outputs to a user such as displays, such as a display screen, indicator or other lights, audio devices to generate notifications or other audible functions. UI component 124 may also include inputs such as knobs, switches, keyboards, touch screens or similar types of input devices.

Interpretation component 118 may be configured to receive an image of an indication of a temporary zone and process the image of the temporary zone to obtain the indication of the temporary zone. In examples in which the indication of the temporary zone is code 126, interpretation component 118 may be configured to receive an image of code 126 and process the image of code 126 to obtain code 126. For example, interpretation component 118 may be communicatively coupled to at least one of image capture devices 102 and configured to receive the image of code 126 from the at least one of image capture devices 102. Interpretation component 118 may be configured to process the image of code 126 to obtain code 126, such as by using image processing techniques.

In examples where the indication of the temporary zone includes code 126, once interpretation component 118 has obtained code 126, interpretation component 118 may be configured to interpret code 126 to obtain information related to navigation of the temporary zone. In some examples, interpretation component 118 may use decoding information to determine the information related to navigation of the temporary zone from code 126. In some examples, such as where decoding information regarding code 126 is stored on computing device 116, interpretation component 118 may obtain the information by looking up code 126 in a database or other log. In some examples, such as where decoding information regarding code 126 is stored remotely, interpretation component 118 may send code 126 to an external database for decoding, such as an external database of computing device 134. In this way, interpretation component 118 may provide information, directly or indirectly, to vehicle control component 144 related to navigation of the temporary zone. As will be described below, the provided information may be used to modify a mode of autonomous operation of PAAV 110.

In some examples, information related to navigation of the temporary zone includes a set of operating rules (also referred to as an “operating rule set”) used by PAAV 110 to navigate the temporary zone. For example, as will be explained below, vehicle control component 144 may operate according to operating rules of one or more operating rule sets. An operating rule may be any navigational rule based on navigational characteristics of pathway 106, including the temporary zone, and associated with autonomous or semi-autonomous operation of PAAV 110. An operating rule set may describe navigational characteristics of the temporary zone. For example, a temporary zone may have specific navigational characteristics that require or recommend a particular operating rule set. The particular operating rule set may, for example, change a priority of information received from sensors, change a response of PAAV 110 to a navigational stimulus, and the like. A change in an operating rule set of PAAV 110 may result in a change in how PAAV 110 responds to a particular navigational stimulus. Operating rules that may be used include, but are not limited to, speed limits, acceleration limits, braking limits, following distance limits, lane markings, distance limits from workers, and the like.

In some examples, code 126 indicates an operating rule set for PAAV 110 to navigate the temporary zone. Interpretation component 118 may obtain the operating rule set based on the interpretation of code 126. For example, code 126 may indicate a particular operating rule set associated with the temporary zone. In some examples, interpretation component 118 may obtain the operating rule set from storage (e.g. memory) located on computing device 116. For example, code 126 may be a standardized code associated with a category of temporary zone, such that interpretation component 118 may look up the operating rule set associated with that category of temporary zone. As another example, code 126 may indicate a set of at least one operation to be applied by PAAV 110, such as “apply brakes” or “switch to driver control” or “move to left lane.” In such examples, interpretation component 118 accesses a local or remote data structure mapping code 126 to the set of operations to be applied by PAAV 110 and provides the set of operations to vehicle control component 144 to modify the operation of the PAAV 110.

In some examples, interpretation component 118 may obtain the operating rule set from an external device, such as computing device 134 through network 114. For example, interpretation component 118 may output a request to computing device 134 for the operating rule set. For example, a temporary zone may include unique navigational characteristics that utilize a unique operating rule set. By including an operating rule set on a centralized server, such as a server controlled by a same entity as the temporary zone, PAAV 110 may PAAV may better navigate the temporary zone based on the operating rule set.

In some examples, information related to navigation of the temporary zone includes a classification of the temporary zone that corresponds to a level of autonomous operation of PAAV 110. For example, a temporary zone may be classified based on a complexity of the navigational characteristics of the temporary zone. In some instances, this classification may correspond to an upper limit on autonomous operation within the temporary zone. For example, a temporary zone may be so complex that autonomous operation of a vehicle through the temporary zone may be limited to levels of autonomous operation in which a human driver monitors the driving environment (i.e. levels 0-2 of SAE J3016 levels of autonomy). In some instances, this classification may correspond to a lower limit on autonomous operation within the temporary zone. For example, a temporary zone may include sudden and unpredictable infrastructure changes, such that autonomous operation of a vehicle may be limited to levels of autonomous operation in which a human driver is not a fallback performer (i.e. levels 4-5 of SAE J3016 levels of autonomy). A change in a level of autonomous operation of PAAV 110 may result in a change in how PAAV 110 responds to a particular navigational stimulus.

In some examples, code 126 indicates a level of autonomous operation of PAAV 110 required to navigate the temporary zone. Interpretation component 118 may obtain a level of autonomous operation of PAAV 110 based on the interpretation of code 126. In some examples, code 126 may indicate a threshold level of autonomous operation for the temporary zone. For example, a temporary zone may not be safe for a high level of autonomous operation due to navigational characteristics of the temporary zone, such as complex instructions or particular safety considerations such as unpredictable operations of road workers and road working equipment. As such, code 126 may indicate a maximum level of autonomous operation permitted for PAAV 110 within the temporary zone. As another example, a temporary zone may not be safe for a low level of autonomous operation due to navigational characteristics of the temporary zone, such as features that may not allow a hand-off to an operator. As such, code 126 may indicate a minimum level of autonomous operation permitted for PAAV 110 within the temporary zone. In some examples, interpretation component 118 may obtain the level of autonomous operation locally, such as from storage located on computing device 116, or remotely, such as from storage located on computing device 134.

In some examples, computing device 116 may use information from interpretation component 118 to generate notifications for a user of PAAV 110, e.g., notifications that indicate a navigational characteristic or condition of vehicle pathway 106. For example, in response to interpretation component 118 obtaining code 126 corresponding to a temporary zone, computing device 116 may output a notification that PAAV 110 is approaching a temporary zone. The notification may notify an operator of PAAV 110 that the operator may be required to resume manual operation of PAAV 110.

In some examples, computing device 116 may include classification component 128. Classification component 128 may determine a classification of a temporary zone based on navigational characteristics of the temporary zone. For example, the operating characteristics of the temporary zone may frequently change based on local conditions, such as traffic and weather, that are outside the control of operators of the temporary zone. As such, rather than rely solely on static or dynamic information from, for example, an indication of the temporary zone such as code 126, classification component 128 may receive real-time information obtained by PAAV 110 or other decentralized sources (i.e. sources other than from operators of the temporary zone) to supplement or replace information indicated by code 126.

In some examples, classification component 128 may collect, in response to receiving an indication of a temporary zone, environmental information related to navigational characteristics of the temporary zone. Environmental information related to navigational characteristics of the temporary zone may include any data received from sensors, external devices, or any other source that may assist in classifying the temporary zone. Classification component 128 may receive data regarding navigational characteristics of the temporary zone. Classification component 128 may receive data from a variety of inputs. In some examples, classification component 128 may receive data indicated by code 126, as described above. For example, classification component 128 may receive an operating rule set or threshold level of autonomous operation indicated by code 126.

In some examples, classification component 128 receives data from sensors of PAAV 110. For example, classification component 128 may receive images of navigational characteristics of the temporary zone from image capture devices 102. Data from sensors of PAAV 110 may include, but are not limited to, weather conditions, traffic data, GPS data, road conditions, pathway articles such as markers 111, and the like. Sensors from which data may be collected may include, but are not limited to, temperature sensors, GPS devices, LIDAR, and RADAR.

In some examples, classification component 128 may be configured to receive an image that includes an indication of the temporary zone and classify the temporary zone based on at least one of the image of the indication of the temporary zone and navigational characteristics of the temporary zone represented in the image. For example, the image of the indication of the temporary zone may be an image of a construction sign, traffic cone, or other object that indicates a temporary zone. The image of the temporary zone may represent navigational characteristics of the temporary zone. For example, a traffic cone may indicate a temporary lane of the temporary zone.

In some examples, classification component 128 receives data from an external device. For example, computing device 134 may include a database that includes navigational characteristics of the temporary zone, such as traffic pattern changes, presence of workers, lane width modification, curves, and shifts, road surface quality, and the like. In some examples, computing device 134 may include a database that includes navigational conditions of the temporary zone, such as location data, congestion data, vehicle behavior variability, speed, lane departure, acceleration data, brake actuation data, and the like. Such navigational characteristics and conditions may be official data, such as supplied by operators having control of the temporary zone or may be crowdsourced data, such as supplied by users travelling through the temporary zone.

Classification component 128 may determine the classification of the temporary zone based on the data. For example, classification component 128 may receive the data from various inputs and determine a navigational complexity of the temporary zone based on the received data. The navigational complexity of the temporary zone may represent the sensory and computational complexity of the navigational characteristics of the temporary zone. For example, the navigational complexity of the temporary zone may provide PAAV 110 with information sufficient to determine whether PAAV 110 may navigate the temporary zone in a particular mode of autonomous operation. In some examples, classification component 128 may apply a trained neural network to determine the classification of the temporary zone. For example, the neural network may receive navigational data from a variety of inputs, such as sensory data, mapping data, weather data, transient/dynamic data (e.g. worker presence), and operating rule set information. The neural network may classify the temporary zone based on the navigational data and a trained set, such as by using parameterized algorithms or models that include weights for the various navigational data inputs. Classification component 128 may output a set of confidence levels based on a variety of inputs.

In some examples, the classification of the temporary zone may correspond to a level of autonomous operation of PAAV 110. For example, classification component 128 may receive data from various sensors and determine navigational characteristics of the temporary zone of pathway 106 based on the received data. Classification component 128 may classify the navigational characteristics of temporary zone and determine a level of autonomous operation that can safely handle the navigational characteristics. For example, if the navigational characteristics of a temporary zone require lateral and longitudinal motion control of PAAV 110, classification component 128 may classify the temporary zone as corresponding to level 1 driving automation as defined by J3016. The level of autonomous operation of PAAV 110 may be associated with various dynamic driving tasks that involve varying levels of complexity. For example, dynamic driving tasks may include longitudinal motion control such as acceleration, braking, and forward collision avoidance; lateral motion control such as steering and free collision; and the like. In some examples, the level of autonomous operation may be associated with various advanced driver assistant system (ADAS) functions, such as adaptive cruise control, adaptive light control, automatic braking, automatic parking, blind spot detection, collision avoidance systems, GPS navigation, driver drowsiness detection, hill descent control, intelligent speed adaptation, night vision, lane departure warning, forward collision warning, and the like.

Computing device 116 includes vehicle control component 144 to control autonomous operation of PAAV 110. Vehicle control component 144 may be configured to receive information indicated by code 126. In some examples, vehicle control component 144 may receive an operating rule set that describes navigational characteristics of the temporary zone. For example, in response to interpretation component 118 outputting a request for the operating rule set, vehicle control component 144 may receive the operating rule set. In some examples, vehicle control component 144 may receive a classification of the temporary zone, such as a level or threshold level of autonomous operation for the temporary zone.

In some examples, vehicle control component 144 may be configured to output, based on the indication of the temporary zone, information to perform at least one operation of PAAV 110 within the temporary zone on the vehicle pathway. For example, vehicle control component 144 may be configured to output any information to a component of PAAV 110 to perform an operation of PAAV 110, such as navigation of the temporary zone or notification of the temporary zone to an operator of PAAV 110.

In some examples, vehicle control component 144 may be configured to output, based on the indication of the temporary zone and to a pathway-article assisted vehicle (PAAV), a mode of autonomous operation of the PAAV for operation of the PAAV within the temporary zone on the vehicle pathway. A mode of autonomous operation may represent a set of autonomous or semi-autonomous responses of PAAV 110 to navigational stimuli received by PAAV 110. Navigational stimuli may include any sensory input that may be used for navigation. Vehicle control component 144 may output the mode of autonomous operation to, for example a component of PAAV 110 responsible for controlling navigational operations of PAAV 110.

In some examples, such as examples in which vehicle control component 144 is responsible for directly controlling navigation of PAAV 110, vehicle control component 144 may be configured to modify, based on the indication of the temporary zone, the mode of autonomous operation of PAAV 110 while operating within the temporary zone on the vehicle pathway. For example, PAAV 110 may detect a navigational stimulus from a sensor, such as a lane marker from one of image capture devices 102. Based on characteristics of the lane marker, such as a position of the lane marker with respect to PAAV 110, PAAV 110 may perform a first operation, such as notifying a driver that the lane marker is near, in a first mode of autonomous operation and perform a second operation, such as avoiding the lane marker, in a second mode of operation. As such, a change in a mode of autonomous operation may include changing a response of PAAV 110 to the navigational stimulus, such as through different operating rules or different levels of autonomous operation.

In examples where the indication of the temporary zone includes code 126, vehicle control component 144 may be configured to modify, based on the information indicated by code 126, a mode of autonomous operation of PAAV 110 while operating within the temporary zone. In some examples, such as examples where code 126 indicates an operating rule set for the temporary zone, vehicle control component 144 may be configured to modify the mode of autonomous operation by updating a current operating rule set with the operating rule set indicated by code 126. For example, vehicle control component 144 may direct operations of PAAV 110, such as responses of PAAV 110 to navigational stimuli, within the temporary zone according to the updated operating rule set. The updated operating rule set may provide vehicle control component 144 with supplemental or replacement operating rules that may be directed toward localized conditions in the temporary zone.

In some examples, vehicle control component 144 may be configured to modify the mode of autonomous operation by changing a level of autonomous operation to the level of or within the threshold of autonomous operation indicated by code 126. For example, if code 126 indicates a maximum level of autonomous operation permitted for PAAV 110 within the temporary zone and vehicle control component 144 is operating PAAV 110 above the maximum level of autonomous operation permitted for PAAV 110, vehicle control component 144 may reduce the level of autonomous operation of the PAAV to the maximum level indicated by code 126, such as by outputting a reduced level of autonomous operation or selecting an operating rule set associated with a reduced level of autonomous operation. As another example, if code 126 indicates a minimum level of autonomous operation permitted for PAAV 110 within the temporary zone and vehicle control component 144 is operating PAAV 110 below the minimum level of autonomous operation permitted for PAAV 110, vehicle control component 144 may determine PAAV 110 does not have a level of autonomous vehicle operation capability to meet the minimum level indicated by code 126 and output an alert to a driver to begin non-autonomous operation of PAAV 110.

In some examples, vehicle control component 144 may be configured to change a level of autonomous operation based on a variety of factors from a variety of sources and/or stakeholders that include navigational and non-navigational characteristics of the temporary zone, PAAV 110, and/or an operator of PAAV 110. In some examples, vehicle control component 144 may select a level of autonomous operation based on legal requirements. For example, an operator of PAAV 110 may have an associated status based a number of points on an operator's license, whether the operator has had a driving under the influence (DUI) conviction, a breathalyzer test of the operator, endorsements, or restrictions of the operation (e.g., vision test), or the like. Based on the associated status of the operator, PAAV 110 may be required to operate autonomously within the temporary zone. As another example, the temporary zone may have an associated requirement based on a jurisdiction of the temporary zone, such as a by a location or funding source (e.g., state, municipal, etc.).

In some examples, vehicle control component 144 may select a level of autonomous operation based on navigational factors, such as may be established by the entity controlling the temporary zone (e.g., Department of Transportation). For example, a maximum or minimum level of autonomous operation may be based on road conditions, temporary zone conditions (e.g., whether workers are present, whether equipment is present, a time of day, weather), a temporary zone type (e.g., school zone, emergency event, street cleaning, snow plowing, etc.), and the like.

In some examples, vehicle control component 14 may select a level of autonomous operation based on insurance requirements, such as may be established by an insurance company or other financially interested third party. For example, a minimum or maximum level of autonomous operation may be based on driving history or habits of an operator of PAAV 110, a type of policy associated with PAAV 110 or an operator of PAAV 110, safety/sensor equipment in PAAV 110, driving location/regulations (e.g., speed limit, crash frequency at a location, etc.), and the like.

In some examples, vehicle control component 144 may select a level of autonomous operation based on operation, status, condition, or manufacturer requirements of PAAV 110, such as may be encountered by PAAV 110 or established by a manufacturer of PAAV 110. For example, a level of autonomous operation may be based on a type of insurance policy of PAAV 110, safety/sensor equipment in PAAV 110, current weather conditions, warranty/repair status of PAAV 110, sensor condition/capability of PAAV 110, and the like. In some examples, vehicle control component 144 may select a level of autonomous operation of PAAV 110 based on operator preferences or characteristics. For example, a level of autonomous operation may be based on personal operator preferences, a level of insurance policy, an alertness of the operator, and the like.

Vehicle control component 144 may include, for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed as a result of these changes. In some examples, the computing device initiates the determined adjustment for one or more functions of PAAV 110 based on the second information in conjunction with a human operator that alters one or more functions of PAAV 110 based on the first information.

In some examples, the mode of autonomous vehicle operation of PAAV 110 is based on at least one of capabilities of one or more sensors of PAAV 110 and capabilities of navigational software of the PAAV. For example, the one or more sensors of PAAV 110 and capabilities of navigational software of PAAV may at least partly determine the navigational capabilities of vehicle control component 144 by determining the type and/or complexity of sensory information from pathway 106 and/or the complexity of navigational decisions based on the sensory information. For example, the capabilities of the one or more sensors and the navigational software include at least one of a minimum version of the navigational software and minimum operating requirements of the one or more sensors. In some examples, the level of autonomous operation corresponds to an industry standard, such as a level of driving autonomation as defined in Society of Automotive Engineers (SAE) International J3016, US National Highway Traffic Safety Administration (NHTSA), and German Federal Highway Research Institute (BASt).

The pathway article of this disclosure is just one piece of redundant information that computing device 116, or a human operator, may consider when operating a vehicle. Other information may include information from other sensors, such as radar or ultrasound distance sensors, lane markings on the vehicle pathway captured from image capture devices 102, information from GPS, and the like. Computing device 116 may consider the various inputs (p) and consider each with a weighting value, such as in a decision equation, as local information to improve the decision process. One possible decision equation may include:

D=w₁*p₁+w₂*p₂+ . . . wₙ*pₙ+w_{PA}*p_{PA}

where the weights (w₁-wₙ) may be a function of the information received from pathway article 108 (p_{PA}). In the example of a construction zone, an enhanced sign may indicate a lane shift from the construction zone. Therefore, computing device 116 may de-prioritize signals from lane marking detection systems when operating the vehicle in the construction zone.

In some examples, PAAV 110 may be a test vehicle that may determine one or more navigational characteristics of vehicle pathway 106 and may include additional sensors as well as components to communicate to a database that includes information related to navigation of the temporary zone. As a test vehicle, PAAV 110 may be autonomous, remotely controlled, semi-autonomous or manually controlled. One example application may be to determine a change in vehicle pathway 106 near a construction zone. Once the construction zone workers mark the change with barriers, traffic cones or similar markings, PAAV 110 may traverse the changed pathway to determine characteristics of the pathway. Some examples may include a lane shift, closed lanes, detour to an alternate route and similar changes. The computing device onboard the test device, such as computing device 116 onboard PAAV 110, may assemble the characteristics of the vehicle pathway into data that contains the characteristics, or attributes, of the vehicle pathway.

In the example of FIG. 1, computing device 134 includes rule component 130. Computing device 116 may communicate to computing device 134, which may control rule component 130. Rule component 130 may include information indicated by code 126. In some examples, rule component 130 is configured to store and maintain information related to navigation of the temporary zone. For example, rule component 130 may include one or more databases configured to store operating rule sets, classification levels, and other information related to navigation of the temporary zone. Rule component 130 may be configured to receive a request for information indicated by code 126, such as an operating rule set, look up the information indicated by code 126, and output the information indicated by code 126, such as to vehicle control component 144.

According to aspects of this disclosure, in operation, interpretation component 118 may receive an image of code 126 of pathway article 108 via image capture circuitry 102C and process the image to obtain code 126. Interpretation component 118 may interpret code 126, such as by looking up code 126 in a table, to obtain information related to navigation of a temporary zone.

In some examples, such as examples where code 126 indicates a start of the temporary zone, interpretation component 118 may determine that code 126 indicates the start of the temporary zone and send the determination to classification component 128. In response to receiving the determination of the start of the temporary zone, classification component 128 may receive real-time sensory information for the temporary zone and determine a classification of the temporary zone based, at least in part, on the real-time sensory information. For example, classification component 128 may receive images of navigational characteristics of the temporary zone, such as from image capture devices 102, and determine a classification level of the temporary zone based on the images of the navigational characteristics of the temporary zone. As another example, classification component 128 may discern and prioritize data from different sensory sources and shift a sensory focus to more local navigation techniques. Classification component 128 may send the determined classification of the temporary zone to vehicle control component 144.

In some examples, such as examples where code 126 indicates a classification of the temporary zone, interpretation component 118 may determine that code 126 indicates a classification of the temporary zone and send an indication of the classification to vehicle control component 144. In response to receiving the indication of the classification of the temporary zone, vehicle control component 144 may modify a mode of autonomous operation of PAAV 110 based on the classification of the temporary zone. For example, vehicle control component 144 may change a level of autonomous operation of PAAV 110 to a level of autonomous operation that corresponds to the classification of the temporary zone.

In some examples, such as examples where code 126 indicates an operating rule set for the temporary zone, interpretation component 118 may determine that code 126 indicates the operating rule set of the temporary zone and send a request for the operating rule set to computing device 134. In response to receiving the requested operating rule set, vehicle control component 144 may modify the mode of autonomous operation of PAAV 110 based on the operating rule set. For example, vehicle control component 144 may update (i.e. supplement or replace) an operating rule set of PAAV 110 with the operating rule set that corresponds to the temporary zone.

By using information related to navigation of the temporary zone to direct autonomous operation of PAAV 110 through the temporary zone, computing device 116 may more accurately, safely, and/or effectively navigate the temporary zone. For example, computing device 116 may direct autonomous operation of PAAV 110 using an operating rule set that customized to the temporary zone and updated in real-time based on changes to the temporary zone. As another example, computing device 116 may direct autonomous operation of PAAV 110 at a level of autonomous operation that is appropriate for the navigational characteristics of the temporary zone.

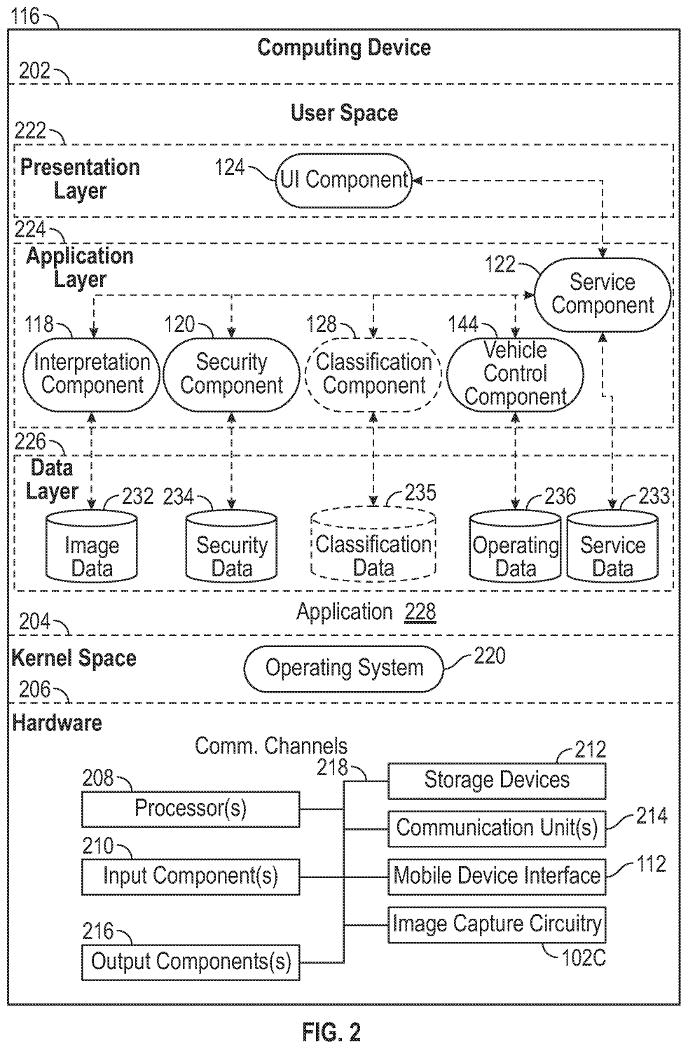

FIG. 2 is a block diagram illustrating an example computing device, in accordance with one or more aspects of the present disclosure. FIG. 2 illustrates only one example of a computing device. Many other examples of computing device 116 may be used in other instances and may include a subset of the components included in example computing device 116 or may include additional components not shown example computing device 116 in FIG. 2.

In some examples, computing device 116 may be a server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard PAAV 110, depicted in FIG. 1. In other examples, computing device 116 may also be part of a system or device that determines one or more operating rule sets for a temporary zone and may correspond to computing device 134 depicted in FIG. 1.

As shown in the example of FIG. 2, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202.

As shown in FIG. 2, hardware 206 includes one or more processors 208, input components 210, storage devices 212, communication units 214, output components 216, mobile device interface 112, and image capture circuitry 102C. Processors 208, input components 210, storage devices 212, communication units 214, output components 216, mobile device interface 112, and image capture circuitry 102C may each be interconnected by one or more communication channels 218.

Communication channels 218 may interconnect each of the components 102C, 104, 208, 210, 212, 214, and 216 for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of computing device 116 may receive input. Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes information regarding a vehicle pathway, such as an operating rule set for navigating the vehicle pathway or a level of autonomous control of the vehicle pathway. In examples where computing device 116 is part of a vehicle, such as PAAV 110 depicted in FIG. 1, communication units 214 may receive information about a pathway article from an image capture device, as described in relation to FIG. 1. In other examples, such as examples where computing device 116 is part of a system or device that determines one or more operating rule sets of a temporary zone, communication units 214 may receive data from a test vehicle, handheld device or other means that may gather data that indicates the navigational characteristics of a vehicle pathway, as described above in FIG. 1 and in more detail below. Computing device 116 may receive updated information, upgrades to software, firmware, and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116, but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Output components 216 may also include vehicle control component 144, in examples where computing device 116 is onboard a PAAV. Vehicle control component 144 has the same functions as vehicle control component 144 described in relation to FIG. 1.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 2, application 228 executes in user space 202 of computing device 116. Application 228 may be logically divided into presentation layer 222, application layer 224, and data layer 226. Presentation layer 222 may include user interface (UI) component 228, which generates and renders user interfaces of application 228. Application 228 may include, but is not limited to: UI component 124, interpretation component 118, security component 120, and one or more service components 122. For instance, application layer 224 may interpretation component 118, service component 122, and security component 120. Presentation layer 222 may include UI component 124.

Data layer 226 may include one or more datastores. A datastore may store data in structure or unstructured form. Example datastores may be any one or more of a relational database management system, online analytical processing database, table, or any other suitable structure for storing data.

Security data 234 may include data specifying one or more validation functions and/or validation configurations. Service data 233 may include any data to provide and/or resulting from providing a service of service component 122. For instance, service data may include information about pathway articles (e.g., security specifications), user information, operating rule sets, levels of autonomous operation, or any other information transmitted between one or more components of computing device 116. Image data 232 may include one or more images of code 126 that are received from one or more image capture devices, such as image capture devices 102 described in relation to FIG. 1. In some examples, the images are bitmaps, Joint Photographic Experts Group images (JPEGs), Portable Network Graphics images (PNGs), or any other suitable graphics file formats. Classification data 235 may include data for classifying a temporary zone based on navigational characteristics. For example, classification data may include weightings and priority factors for scoring navigational stimuli to determine navigational characteristics. Operating data 236 may include instructions for operating PAAV 110. Operating data may include one or more operating rule sets, one or more operating protocols for various levels of autonomous operation, and the like.

In the example of FIG. 2, one or more of communication units 214 may receive, from an image capture device, an image of a pathway article that includes a code indicative of a temporary zone embedded thereon, such as code 126 in FIG. 1. In some examples, UI component 124 or any one or more components of application layer 224 may receive the image of code 126 and store the image in image data 232.

In response to receiving the image of code 126, interpretation component 118 may process the image of code 126 to obtain code 126. Code 126 may indicate information related to navigation of the temporary zone. Interpretation component 118 may interpret code 126 to obtain the information related to navigation of the temporary zone, such as by using decoding information from image data 232. Interpretation component 118 may provide the information related to navigation of the temporary zone to vehicle control component 144. Computing device 116 may combine this information with other information from other sensors, such as image capture devices, GPS information, information from network 114 and similar information to adjust the speed, suspension, or other functions of the vehicle through vehicle control component 144.

In some examples, code 126 may indicate a classification of the temporary zone. The classification of the temporary zone may represent the complexity of navigational characteristics of the temporary zone. Interpretation component 118 may determine the classification of the temporary zone based on code 126 and send an indication of the classification to vehicle control component 144. Vehicle control component 144 may determine a level of autonomous operation based on the classification of the temporary zone. For example, if the classification is associated with a particular level or threshold level of autonomous operation, such as a level of driving automation per SAE J3016, vehicle control component 144 may select a level of autonomous operation that matches the particular level or is within the particular threshold level of autonomous operation associated with the classification. As another example, if the classification is associated with particular navigational capabilities of a vehicle operating in the temporary zone, such as particular dynamic driving tasks, vehicle control component 144 may select a level of autonomous operation that meets or exceeds the particular navigational capabilities. For example, if PAAV 110 is capable of autonomous longitudinal motion control within a specified responsiveness threshold for the temporary zone, but not autonomous lateral motion control within a specified responsiveness threshold for the temporary zone, vehicle control component 144 may select a level of autonomous operation that includes autonomous longitudinal motion control, but not autonomous lateral motion control.

In some examples, code 126 may indicate a start of the temporary zone. Classification component 128 may determine a classification of the temporary zone based on navigational characteristics of the temporary zone. For example, classification component 128 may receive classification data, such as from classification data 235, that represents a scoring or weighting of various navigational characteristics of the temporary zone. Based on the scoring or weighting of the various navigational characteristics, classification component 128 may determine the classification of the temporary zone and output an indication of the classification to vehicle control component 144. Vehicle control component 144 may determine a level of autonomous operation based on the classification of the temporary zone, as described above.

Vehicle control component 144 may modify a mode of autonomous operation of PAAV 110 by selecting the determined level of autonomous operation and directing operations of PAAV 110 according to the selected level of autonomous operation while operating within the temporary zone. For example, vehicle control component 144 may reduce a level of autonomous operation of PAAV 110 for the duration of the temporary zone and assume a previous level of autonomous operation once PAAV 110 is out of the temporary zone.

In some examples, code 126 may indicate an operating rule set of the temporary zone. The operating rule set of the temporary rule zone may represent one or more rules for navigating the navigational characteristics of the temporary zone. Interpretation component 118 may determine the operating rule set of the temporary zone based on code 126 and send an indication of the operating rule set to vehicle control component 144. In response to receiving the indication of the operating rule set, vehicle control component 144 may select the operating rule set, such as from operating data 236.

Vehicle control component 144 may modify a mode of autonomous operation of PAAV 110 by selecting the determined operating rule set and directing operations of PAAV 110 according to the selected operating rule set while operating within the temporary zone. For example, vehicle control component 144 may operate PAAV 110 with the operating rule set for the temporary zone while in the temporary zone and may operate PAAV 110 with a previous operating rule set once PAAV 110 is no longer in the temporary zone.

While interpretation component 118 has been described as providing information, such as an indication of a classification or operation rule set, directly to vehicle control component 144, in some examples, interpretation component 118 may indirectly provide information to vehicle control component 144. For example, code 126 may be a link or other reference to an external device, such as computing device 134 of FIG. 1, that includes information related to navigation of the temporary zone. Interpretation component 118 may send a request for the information related to navigation of the temporary zone to computing device 134. In response, computing device 134 may send the requested information to vehicle control component 144. Vehicle control component 144 may receive dynamic information related to navigation of the temporary zone. In this way, code 126 may act as a pointer to a database entry and a reference for digitally-connected information regarding the temporary zone that enables specific, dynamic content delivery and improves decision making, safety, and efficiency.

In some examples, the pathway articles of this disclosure may include one or more security elements to help determine if the pathway article is counterfeit. Security component 120 may determine whether pathway article, such as pathway article 108, is counterfeit based at least in part on determining whether the code, such as code 126, is valid for at least one security element. As described in relation to FIG. 1 security component 120 may include one or more validation functions and/or one or more validation conditions on which the construction of pathway article 108 is based. In other examples a pathway article may include one or more security elements. In FIG. 2, security component 120 determines, using a validation function based on the validation condition in security data 234, whether the pathway article depicted in FIG. 1 is counterfeit. Security component 120, based on determining that the security elements satisfy the validation configuration, generate data that indicates pathway article 108 is authentic (e.g., not a counterfeit). If security elements and the article message in pathway article 108 did not satisfy the validation criteria, security component 120 may generate data that indicates pathway article is not authentic (e.g., counterfeit) or that the pathway article is not being read correctly.

Service component 122 may perform one or more operations based on the data generated by security component 120 that indicates whether the pathway article is a counterfeit. Service component 122 may, for example, query service data 233 to retrieve a list of recipients for sending a notification or store information that indicates details of the image of the pathway article (e.g., object to which pathway article is attached, image itself, metadata of image (e.g., time, date, location, etc.)). In response to, for example, determining that PAAV 110 does not have a level of autonomous vehicle operation capability to meet a minimum level, service component 122 may send data to UI component 124 that causes UI component 124 to generate an alert to a driver to begin non-autonomous operation of PAAV 110. UI component 124 may send data to an output component of output components 216 that causes the output component to display the alert.

By using information related to navigation of the temporary zone to direct autonomous operation of PAAV 110 through the temporary zone, computing device 116 may more accurately, safely, and/or effectively navigate the temporary zone. For example, computing device 116 may direct autonomous operation of PAAV 110 using an operating rule set that customized to the temporary zone and updated in real-time based on changes to the temporary zone. As another example, computing device 116 may direct autonomous operation of PAAV 110 at a level of autonomous operation that is appropriate for the navigational characteristics of the temporary zone.

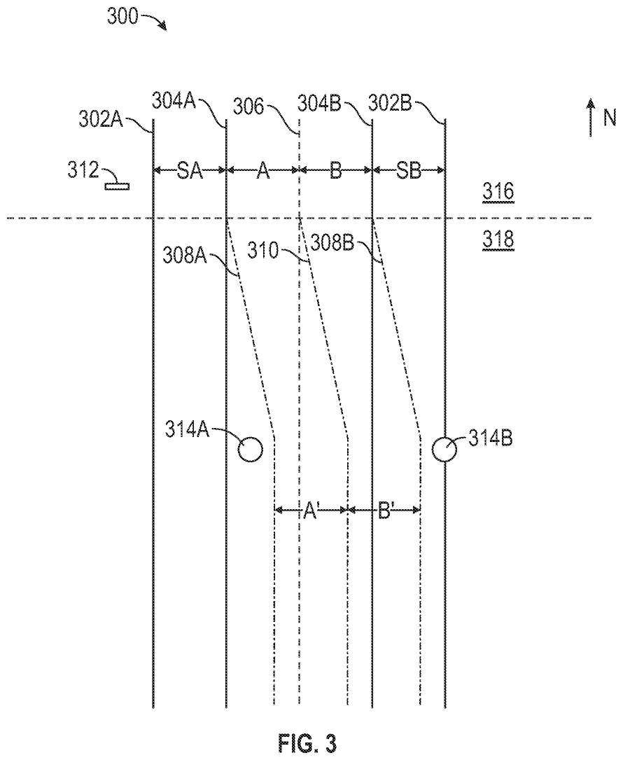

FIG. 3 is a diagram of an example roadway 300 that may be navigated by a PAAV as described herein. FIG. 3 will be described with reference to PAAV 110 of FIG. 1.

Roadway 300 includes a regular zone 316 (i.e. a non-temporary zone) and a temporary zone 318. Regular zone 316 of roadway 300 includes a first shoulder SA formed by a first roadway edge 302A and a first lane edge 304A, a first lane A formed by first lane edge 304A and a divider 306, a second lane B formed by divider 306 and a second lane edge 304B, and a second shoulder formed by second lane edge 304B and a second roadway edge 302B.

In the example of FIG. 3, temporary zone 318 is indicated by a pathway article 312 with a code embodied thereon, such as pathway article 108 of FIG. 1. Temporary zone 318 of roadway 300 includes a first temporary lane A′ formed by a first temporary edge 308A and a temporary divider 310 and a second temporary lane B′ formed by temporary divider 310 and a second temporary edge 308B. The temporary zone includes marker 314A outside temporary lane A′ and marker 314B outside temporary lane B′.

In the example of FIG. 3, PAAV 110 (not shown) may encounter temporary zone 318 from regular zone 316. For example, PAAV 110 may be travelling south along roadway 300 in first lane A. Upon encountering pathway article 312, PAAV 110 may generate an image of the code on pathway article 312. Computing device 116 may receive the image of the code and process the image of the code to obtain the code.

In some examples, the code may indicate a start of temporary zone 318. Computing device 116 may modify a mode of autonomous operation of PAAV 110 based on the indication of the start of temporary zone 318. For example, computing device 116 may collect data regarding temporary zone 318, such as presence and location of first and second temporary edges 308, presence and location of temporary divider 310, presence and location of markers 314, previous route of other vehicles travelling through temporary zone 318, and other navigational characteristics of temporary zone 318. Computing device 116 may determine a classification of temporary zone 318 based on the complexity of navigational characteristics of the temporary zone. For example, Computing device 116 may predict capabilities of PAAV 110 required to autonomously navigate temporary zone 318, such as an ability of computing device 116 to differentiate between temporary edges 308 and lane edges 304 based on other context information. Computing device 116 may select a level of autonomous operation based on the classification of temporary zone 318 and direct operation of PAAV 110 based on the selected level of autonomous operation. For example, if computing device 116 predicts that it does not have the ability to safely differentiate between temporary edges 308 and lane edges 304, computing device 116 may select a level of autonomous operation that includes autonomous operation of longitudinal motion control, but manual operation of lateral motion control.

In some examples, the code may indicate a classification of temporary zone 318. For example, the code may indicate a standardized classification of temporary zone 318, such as a classification associated with lane shifts, indicator markers such as markers 314, and other features present in temporary zone 318 that may be common in other temporary zones. Computing device 116 may modify a mode of autonomous operation of PAAV 110 based on the classification of temporary zone 318. Computing device of PAAV 110 may select a level of autonomous operation based on the classification of temporary zone 318. For example, computing device 116 may look up a level of autonomous operation for PAAV 110, such as in a database, that corresponds to the classification indicated by the code and select the level of autonomous operation, such as level 1 of driving autonomy per SAE J3016. As another example, computing device 116 may determine that PAAV 110 does not have a level of autonomous operation capability to meet a minimum level of autonomous operation indicated by the code.

In some examples, the code may indicate an operating rule set of temporary zone 318. For example, the operating rule set may include operating rules for navigating various navigational characteristics of temporary zone 318, such as operating to the left of 314A, operating within temporary lane A′, replacing lane edges 304 with temporary edges 308 for lateral motion guidance, reducing speed, and the like. Computing device 116 may modify a mode of autonomous operation of PAAV 110 based on the operating rule set for temporary zone 318. In some examples, computing device 116 may obtain the operating rule set by looking up the operating rule set, such as in a database, based on the code. For example, the operating rule set may be a standardized operating rule set or a set of standardized operating rules for navigational characteristics included in temporary zone 318. In some examples, computing device 116 may obtain the operating rule set from an external device. For example, the operating rule set may be unique to temporary zone 318 (e.g. stay 3 feet left of marker 314A) or subject to change based on changes to temporary zone 318 (e.g. higher speed limit when workers no longer present). Computing device 116 may direct operations of PAAV 110 according to the operating rule set for temporary zone 318. For example, computing device 116 may ignore lane edges 304 and lane divider 306 and operate within temporary edges 308 and temporary divider 310.

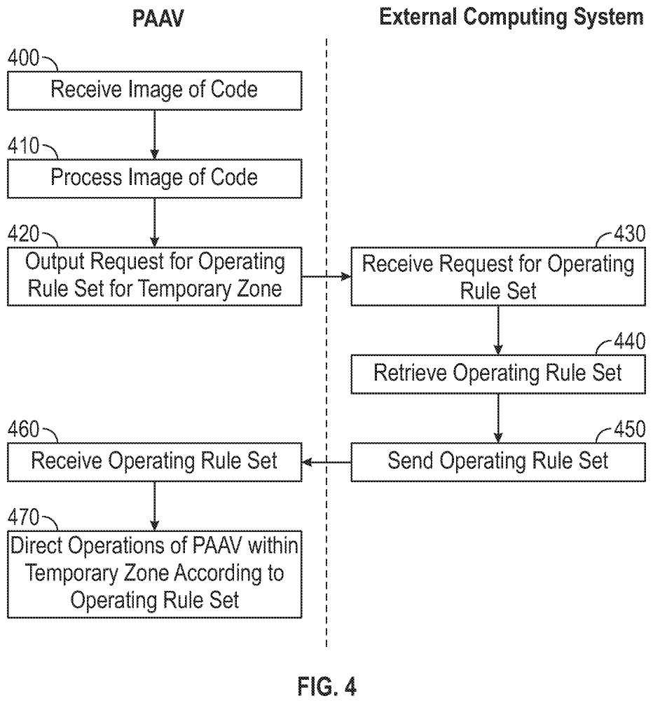

FIG. 4 is a flow diagram illustrating example operation of a computing device for modifying a mode of autonomous operation of a pathway-article assisted vehicle, in accordance with one or more techniques of this disclosure. The techniques are described in terms of computing device 116 and computing device 134 of FIG. 1. However, the techniques may be performed by other computing devices.

In the example of FIG. 4, computing device 116 receives an image of code 126 (400). For example, computing device 116 may receive the image of code 126 from one of image capture devices 102. Computing device 116 processes the image of code 126 to obtain code 126 (410). For example, computing device 116 may use one or more image processing techniques to identify information relating to code 126 and interpret code 126, such as by looking up the information relating to code 126.

Computing device 116 outputs, based on the code, a request to a remote computing device, such as computing device 134 via network 114, for the operating rule set (420). For example, code 126 may be associated with an identifier of an operating rule set associated with the temporary zone and/or a link that identifies a location of the operating rule set. The location may be, for instance, a Uniform Resource Identifier. Computing device 116 may output the request for the operating rule set to computing device 134 based on the identifier and/or link.

Computing device 134 receives the request for the operating rule set (430). In response to receiving the receiving the request, computing device 134 retrieves the operating rule set (440). For example, the request for the operating rule set may include an identifier of the operating rule set. Computing device 134 may look up the operating rule set based on the identifier, such as in a database. Computing device 134 sends the operating rule set to computing device 116 (450).

Computing device 116 receives the operating rule set (460). Computing device 116 directs, according to the operating rule set, operations of PAAV 110 within the temporary zone (470).

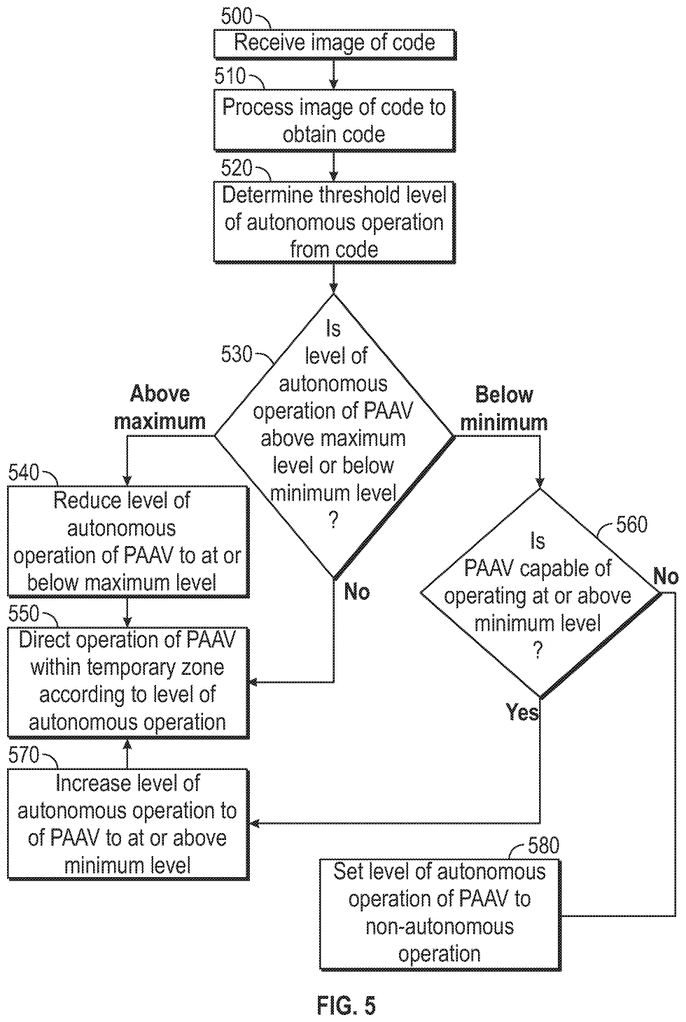

FIG. 5 is a flow diagram illustrating example operation of a computing device for modifying a mode of autonomous operation of a pathway-article assisted vehicle, in accordance with one or more techniques of this disclosure. The techniques are described in terms of computing device 116 of FIG. 1. However, the techniques may be performed by other computing devices.

In the example of FIG. 4, computing device 116 receives an image of code 126 (500). For example, computing device 116 may receive the image of code 126 from one of image capture devices 102. Computing device 116 processes the image of code 126 (510). For example, computing device 116 may use one or more image processing techniques identify information relating to code 126 and interpret code 126, such as by looking up the information relating to code 126. Computing device 116 determines, based on code 126, a threshold level of autonomous operation (520). For example, code 126 may indicate a maximum or minimum level of autonomous operation of the temporary zone. Computing device 116 determines, based on the threshold level of autonomous operation and a current level of autonomous operation of PAAV 110, whether the current level of autonomous operation of PAAV 110 is above a maximum threshold or below a minimum threshold level of autonomous operation for the temporary zone (530).

In examples where code 126 indicates a maximum level of autonomous operation, computing device 116 may determine whether the current level of autonomous operation of PAAV 110 is above the maximum level of autonomous operation. In response to determining that the current level of autonomous operation is above the maximum level of autonomous operation for the temporary zone (“ABOVE MAXIMUM”), computing device 116 may reduce the level of autonomous operation of PAAV 110 to or below the maximum level of autonomous operation indicated by code 126 (550). In response to either reducing the level of autonomous operation of PAAV 110 to or below the maximum level indicated by code 126 or determining that the current level of autonomous operation is at or below the maximum level of autonomous operation for the temporary zone (“NO”), computing device 116 may direct operations of PAAV 110 within the temporary zone according to the current level of autonomous operation.

In examples where code 126 indicates a minimum level of autonomous operation, computing device 116 may determine whether the current level of autonomous operation of PAAV 110 is below the minimum level of autonomous operation. In response to determining that the current level of autonomous operation is below the minimum level of autonomous operation for the temporary zone (“BELOW MINIMUM”), computing device 116 may determine whether PAAV 110 is capable of operating at or above the minimum level of autonomous operation (560). In response to determining that PAAV 110 is capable of operating at or above the minimum level of autonomous operation (“YES”), PAAV 110 may increase the level of autonomous operation to at or above the minimum level of autonomous operation (570). In response to determining that PAAV 110 is not capable of operating at or above the minimum level of autonomous operation (“NO”), computing device 116 may set the level of autonomous operation of PAAV 110 to non-autonomous operation (580).

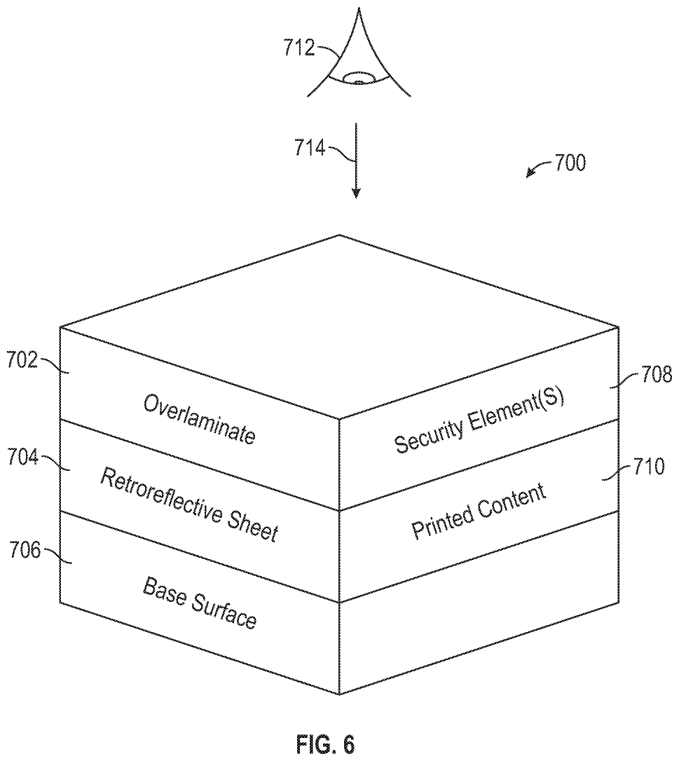

FIG. 6 is a conceptual diagram of a cross-sectional view of a pathway article in accordance with techniques of this disclosure. In some examples, such as an enhanced sign, a pathway article may comprise multiple layers. For purposes of illustration in FIG. 6, a pathway article 700 may include a base surface 706. Base surface 706 may be an aluminum plate or any other rigid, semi-rigid, or flexible surface. Retroreflective sheet 704 may be a retroreflective sheet as described in this disclosure. A layer of adhesive (not shown) may be disposed between retroreflective sheet 704 and base surface 706 to adhere retroreflective sheet 704 to base surface 706.

Pathway article may include an overlaminate 702 that is formed or adhered to retroreflective sheet 704. Overlaminate 702 may be constructed of a visibly-transparent, infrared opaque material, such as but not limited to multilayer optical film as disclosed in U.S. Pat. No. 8,865,293, which is expressly incorporated by reference herein in its entirety. In some construction processes, retroreflective sheet 704 may be printed and then overlaminate 702 subsequently applied to reflective sheet 704. A viewer 712, such as a person or image capture device, may view pathway article 700 in the direction indicated by the arrow 714.

As described in this disclosure, in some examples, an article message, such as code 126 of FIG. 1, may be printed or otherwise included on a retroreflective sheet. In such examples, an overlaminate may be applied over the retroreflective sheet, but the overlaminate may not contain an article message. In the example of FIG. 6, visible portions 710 of the article message may be included in retroreflective sheet 704, but non-visible portions 708 of the article message may be included in overlaminate 702. In some examples, a non-visible portion may be created from or within a visibly-transparent, infrared opaque material that forms an overlaminate. European publication No. EP0416742 describes recognition symbols created from a material that is absorptive in the near infrared spectrum but transparent in the visible spectrum. Suitable near infrared absorbers/visible transmitter materials include dyes disclosed in U.S. Pat. No. 4,581,325. U.S. Pat. No. 7,387,393 describes license plates including infrared-blocking materials that create contrast on a license plate. U.S. Pat. No. 8,865,293 describes positioning an infrared-reflecting material adjacent to a retroreflective or reflective substrate, such that the infrared-reflecting material forms a pattern that can be read by an infrared sensor when the substrate is illuminated by an infrared radiation source. EP0416742 and U.S. Pat. Nos. 4,581,325, 7,387,393 and 8,865,293 are herein expressly incorporated by reference in their entireties. In some examples, overlaminate 702 may be etched with one or more visible or non-visible portions.

In some examples, if overlaminate includes non-visible portions 708 and retroreflective sheet 704 includes visible portions 710 of article message, an image capture device may capture two separate images, where each separate image is captured under a different lighting spectrum or lighting condition. For instance, the image capture device may capture a first image under a first lighting spectrum that spans a lower boundary of infrared light to an upper boundary of 900 nm. The first image may indicate which encoding units are active or inactive. The image capture device may capture a second image under a second lighting spectrum that spans a lower boundary of 900 nm to an upper boundary of infrared light. The second image may indicate which portions of the article message are active or inactive (or present or not present). Any suitable boundary values may be used. In some examples, multiple layers of overlaminate, rather than a single layer of overlaminate 702, may be disposed on retroreflective sheet 704. One or more of the multiple layers of overlaminate may have one or more portions of the article message. Techniques described in this disclosure with respect to the article message may be applied to any of the examples described in FIG. 6 with multiple layers of overlaminate.

In some examples, a laser in a construction device may engrave the article message onto sheeting, which enables embedding markers specifically for predetermined meanings. Example techniques are described in U.S. Provisional Patent Application 62/264,763, filed on Dec. 8, 2015, which is hereby incorporated by reference in its entirety. In such examples, the portions of the article message in the pathway article can be added at print time, rather than being encoded during sheeting manufacture. In some examples, an image capture device may capture an image in which the engraved security elements or other portions of the article message are distinguishable from other content of the pathway article. In some examples the article message may be disposed on the sheeting at a fixed location while in other examples, the article message may be disposed on the sheeting using a mobile construction device, as described above.

The following examples provide other techniques for creating portions of the article message in a pathway article, in which some portions, when captured by an image capture device, may be distinguishable from other content of the pathway article. For instance, a portion of an article message, such as a security element may be created using at least two sets of indicia, wherein the first set is visible in the visible spectrum and substantially invisible or non-interfering when exposed to infrared radiation; and the second set of indicia is invisible in the visible spectrum and visible (or detectable) when exposed to infrared. Patent Publication WO/2015/148426 (Pavelka et al) describes a license plate comprising two sets of information that are visible under different wavelengths. The disclosure of WO/2015/148426 is expressly incorporated herein by reference in its entirety. In yet another example, a security element may be created by changing the optical properties of at least a portion of the underlying substrate. U.S. Pat. No. 7,068,434 (Florczak et al), which is expressly incorporated by reference in its entirety, describes forming a composite image in beaded retroreflective sheet, wherein the composite image appears to be suspended above or below the sheeting (e.g., floating image). U.S. Pat. No. 8,950,877 (Northey et al), which is expressly incorporated by reference in its entirety, describes a prismatic retroreflective sheet including a first portion having a first visual feature and a second portion having a second visual feature different from the first visual feature, wherein the second visual feature forms a security mark. The different visual feature can include at least one of retroreflectance, brightness or whiteness at a given orientation, entrance or observation angle, as well as rotational symmetry. Patent Publication No. 2012/281285 (Orensteen et al), which is expressly incorporated by reference in its entirety, describes creating a security mark in a prismatic retroreflective sheet by irradiating the back side (i.e., the side having prismatic features such as cube corner elements) with a radiation source. U.S. Patent Publication No. 2014/078587 (Orensteen et al), which is expressly incorporated by reference in its entirety, describes a prismatic retroreflective sheet comprising an optically variable mark. The optically variable mark is created during the manufacturing process of the retroreflective sheet, wherein a mold comprising cube corner cavities is provided. The mold is at least partially filled with a radiation curable resin and the radiation curable resin is exposed to a first, patterned irradiation. Each of U.S. Pat. Nos. 7,068,464, 8,950,877, US 2012/281285 and US 2014/078587 are expressly incorporated by reference in its entirety.

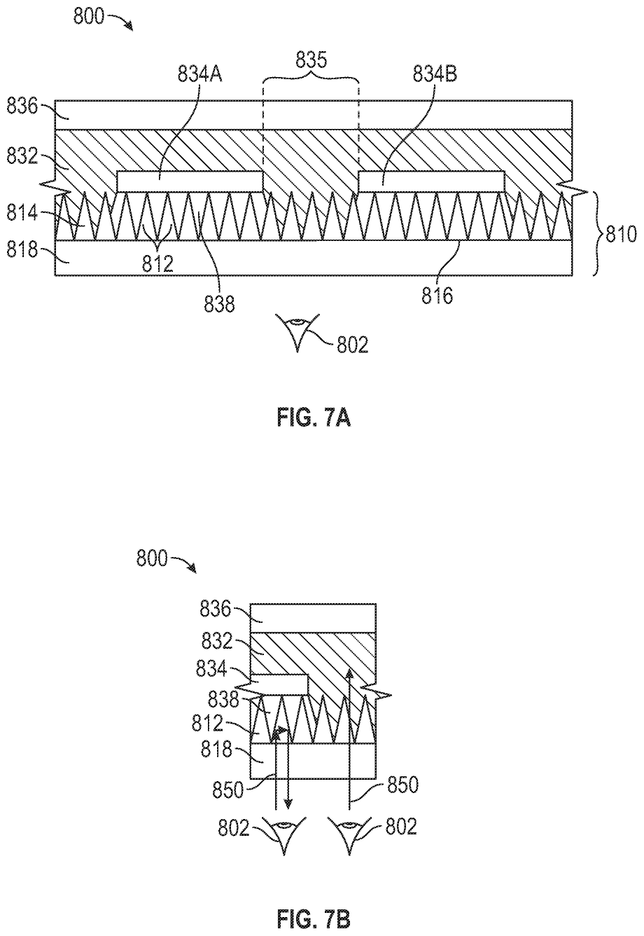

FIGS. 7A and 7B illustrate cross-sectional views of portions of an article message formed on a retroreflective sheet, in accordance with one or more techniques of this disclosure. Retroreflective article 800 includes a retroreflective layer 810 including multiple cube corner elements 812 that collectively form a structured surface 814 opposite a major surface 816. The optical elements can be full cubes, truncated cubes, or preferred geometry (PG) cubes as described in, for example, U.S. Pat. No. 7,422,334, incorporated herein by reference in its entirety. The specific retroreflective layer 810 shown in FIGS. 7A and 7B includes a body layer 818, but those of skill will appreciate that some examples do not include an overlay layer. One or more barrier layers 834 are positioned between retroreflective layer 810 and conforming layer 832, creating a low refractive index area 838. Barrier layers 834 form a physical “barrier” between cube corner elements 812 and conforming layer 832. Barrier layer 834 can directly contact or be spaced apart from or can push slightly into the tips of cube corner elements 812. Barrier layers 834 have a characteristic that varies from a characteristic in one of (1) the areas 832 not including barrier layers (view line of light ray 850) or (2) another barrier layer 834. Exemplary characteristics include, for example, color and infrared absorbency.

In general, any material that prevents the conforming layer material from contacting cube corner elements 812 or flowing or creeping into low refractive index area 838 can be used to form the barrier layer Exemplary materials for use in barrier layer 834 include resins, polymeric materials, dyes, inks (including color-shifting inks), vinyl, inorganic materials, UV-curable polymers, multi-layer optical films (including, for example, color-shifting multi-layer optical films), pigments, particles, and beads. The size and spacing of the one or more barrier layers can be varied. In some examples, the barrier layers may form a pattern on the retroreflective sheet. In some examples, one may wish to reduce the visibility of the pattern on the sheeting. In general, any desired pattern can be generated by combinations of the described techniques, including, for example, indicia such as letters, words, alphanumerics, symbols, graphics, logos, or pictures. The patterns can also be continuous, discontinuous, monotonic, dotted, serpentine, any smoothly varying function, stripes, varying in the machine direction, the transverse direction, or both; the pattern can form an image, logo, or text, and the pattern can include patterned coatings and/or perforations. The pattern can include, for example, an irregular pattern, a regular pattern, a grid, words, graphics, images lines, and intersecting zones that form cells.

The low refractive index area 838 is positioned between (1) one or both of barrier layer 834 and conforming layer 832 and (2) cube corner elements 812. The low refractive index area 838 facilitates total internal reflection such that light that is incident on cube corner elements 812 adjacent to a low refractive index area 838 is retroreflected. As is shown in FIG. 7B, a light ray 850 incident on a cube corner element 812 that is adjacent to low refractive index layer 838 is retroreflected back to viewer 802. For this reason, an area of retroreflective article 800 that includes low refractive index layer 838 can be referred to as an optically active area. In contrast, an area of retroreflective article 800 that does not include low refractive index layer 838 can be referred to as an optically inactive area because it does not substantially retroreflect incident light. As used herein, the term “optically inactive area” refers to an area that is at least 50% less optically active (e.g., retroreflective) than an optically active area. In some examples, the optically inactive area is at least 40% less optically active, or at least 30% less optically active, or at least 20% less optically active, or at least 10% less optically active, or at least at least 5% less optically active than an optically active area.

Low refractive index layer 838 includes a material that has a refractive index that is less than about 1.30, less than about 1.25, less than about 1.2, less than about 1.15, less than about 1.10, or less than about 1.05. In general, any material that prevents the conforming layer material from contacting cube corner elements 812 or flowing or creeping into low refractive index area 838 can be used as the low refractive index material. In some examples, barrier layer 834 has sufficient structural integrity to prevent conforming layer 832 from flowing into a low refractive index area 838. In such examples, low refractive index area may include, for example, a gas (e.g., air, nitrogen, argon, and the like). In other examples, low refractive index area includes a solid or liquid substance that can flow into or be pressed into or onto cube corner elements 812. Exemplary materials include, for example, ultra-low index coatings (those described in PCT Patent Application No. PCT/US2010/031290), and gels.

The portions of conforming layer 832 that are adjacent to or in contact with cube corner elements 812 form non-optically active (e.g., non-retroreflective) areas or cells. In some examples, conforming layer 832 is optically opaque. In some examples conforming layer 832 has a white color.

In some examples, conforming layer 832 is an adhesive. Exemplary adhesives include those described in PCT Patent Application No. PCT/US2010/031290. Where the conforming layer is an adhesive, the conforming layer may assist in holding the entire retroreflective construction together and/or the viscoelastic nature of barrier layers 834 may prevent wetting of cube tips or surfaces either initially during fabrication of the retroreflective article or over time.

In some examples, conforming layer 832 is a pressure sensitive adhesive. The PSTC (pressure sensitive tape council) definition of a pressure sensitive adhesive is an adhesive that is permanently tacky at room temperature which adheres to a variety of surfaces with light pressure (finger pressure) with no phase change (liquid to solid). While most adhesives (e.g., hot melt adhesives) require both heat and pressure to conform, pressure sensitive adhesives typically only require pressure to conform. Exemplary pressure sensitive adhesives include those described in U.S. Pat. No. 6,677,030. Barrier layers 834 may also prevent the pressure sensitive adhesive from wetting out the cube corner sheeting. In other examples, conforming layer 832 is a hot-melt adhesive.

In some examples, a pathway article may use a non-permanent adhesive to attach the article message to the base surface. This may allow the base surface to be re-used for a different article message. Non-permanent adhesive may have advantages in areas such as roadway construction zones where the vehicle pathway may change frequently.

In the example of FIG. 7A, a non-barrier region 835 does not include a barrier layer, such as barrier layer 834. As such, light may reflect with a lower intensity than barrier layers 834A-834B. In some examples, non-barrier region 835 may correspond to an “active” security element. For instance, the entire region or substantially all of image region 142A may be a non-barrier region 835. In some examples, substantially all of image region 142A may be a non-barrier region that covers at least 50% of the area of image region 142A. In some examples, substantially all of image region 142A may be a non-barrier region that covers at least 75% of the area of image region 142A. In some examples, substantially all of image region 142A may be a non-barrier region that covers at least 90% of the area of image region 142A. In some examples, a set of barrier layers (e.g., 834A, 834B) may correspond to an “inactive” security element. In the aforementioned example, an “inactive” security element may have its entire region or substantially all of image region 142D filled with barrier layers. In some examples, substantially all of image region 142D may be a non-barrier region that covers at least 75% of the area of image region 142D. In some examples, substantially all of image region 142D may be a non-barrier region that covers at least 90% of the area of image region 142D. In the foregoing description of FIG. 7 with respect to security layers, in some examples, non-barrier region 835 may correspond to an “inactive” security element while an “active” security element may have its entire region or substantially all of image region 142D filled with barrier layers.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

In some examples, a technique may include receiving an image of a code indicative of a temporary zone on a vehicle pathway, processing the image to obtain the code, and outputting, based on the code to a pathway-article assisted vehicle (PAAV), a mode of autonomous operation of the PAAV while the PAAV is operating within the temporary zone on the vehicle pathway. In some examples, to output the mode of autonomous operation of the PAAV, the technique may include obtaining an operating rule set that describes navigational characteristics of the temporary zone and outputting the operating rule set to direct operations of the PAAV within the temporary zone. In some examples, to obtain the operating rule set, the technique may include outputting, based on the code, a request to a remote computing system for the operating rule set.

In some examples, the code indicates a maximum level of autonomous operation permitted for PAAVs within the temporary zone, such that, to output the mode of autonomous operation of the PAAV, the technique includes outputting the maximum level indicated by the code. In some examples, the code indicates a minimum level of autonomous operation required for PAAVs to operate autonomously within the temporary zone, such that, to output the mode of autonomous vehicle operation, the technique includes determining that the PAAV does not have a level of autonomous vehicle operation capability to meet the minimum level and outputting an alert to a driver to begin non-autonomous operation of the PAAV.

Various examples have been described. These and other examples are within the scope of the following claims.

1-14. (canceled)

15. A computing device comprising:
a memory;
one or more computer processors configured to:
receive an image that includes an indication of a temporary zone on a vehicle pathway;
process the image to obtain the indication of the temporary zone from the image; and
output, based on the indication of the temporary zone and to a pathway-article assisted vehicle (PAAV), a mode of autonomous operation of the PAAV for operation of the PAAV within the temporary zone on the vehicle pathway.

16. The computing device of claim 15, wherein the processors are further configured to collect, in response to receiving the indication of the temporary zone, environmental information related to navigational characteristics of the temporary zone.

17. The computing device of claim 15, wherein the processors are configured to:
classify the temporary zone based at least on the image and on navigational characteristics of the temporary zone represented in the image; and
output, based on the classification of the temporary zone, operations of the PAAV within the temporary zone.

18. The computing device of claim 17, wherein, to classify the temporary zone, the processors are configured to apply a neural network.

19. The computing device of claim 15, wherein, to output the mode of autonomous operation of the PAAV, the computing device is configured to:
obtain an operating rule set that describes navigational characteristics of the temporary zone; and
output, according to the operating rule set, operations of the PAAV within the temporary zone.

20. The computing device of claim 15, wherein the navigational characteristics of the temporary zone include at least one of a traffic pattern change, worker presence, lane modifications, road surface quality, and construction standards changes.

21. The computing device of claim 15, wherein the indication of the temporary zone comprises one or more pathway articles proximate to the vehicle pathway, wherein the one or more pathway articles indicate the temporary zone.

22. The computing device of claim 21, wherein the one or more pathway articles include a code embodied therein, wherein the code indicates the temporary zone.

23. The computing device of claim 22, wherein the computing device is further configured to:
output, based on the code, a request to a remote computing system for the operating rule set.

24. The computing device of claim 22,
wherein the code indicates a maximum level of autonomous operation permitted for PAAVs within the temporary zone, and
wherein, to output the mode of autonomous operation, the computing system is configured to output a reduced level of autonomous operation of the PAAV to the maximum level indicated by the code.

25. The computing device of claim 22,
wherein the code indicates a minimum level of autonomous operation required for PAAVs to operate autonomously within the temporary zone, and
wherein, to output the mode of autonomous operation, the computing system is configured to:
determine the PAAV does not have a level of autonomous operation capability to meet the minimum level; and
output an alert to a driver to begin non-autonomous operation of the PAAV.

26. The computing device of claim 15, wherein the mode of autonomous operation of the PAAV is based on at least one of capabilities of one or more sensors of the PAAV and capabilities of navigational software of the PAAV.

27. The computing device of claim 26, wherein the capabilities of the one or more sensors and the navigational software include at least one of a minimum version of the navigational software and minimum operating requirements of the one or more sensors.

28. The computing device of claim 15, wherein the mode of autonomous operation is a level of autonomy as defined in Society of Automotive Engineers (SAE) International J3016.

29. An article comprising:
a physical surface having a code embodied thereon, wherein the code indicates a temporary zone on a vehicle pathway.

30. The article of claim 29, comprising:
wherein the code is detectable by at least one image capture device mounted within a pathway-article assisted vehicle (PAAV), and
wherein the code is encoded to cause a computing device to modify, based on the code, a mode of autonomous operation of the PAAV while operating within the temporary zone on the vehicle pathway.

31. The article of claim 29, wherein the article comprises one of an optical tag, a road sign, a pavement marker, a radio-frequency identification, a radio-frequency tag, an acoustic surface pattern, and a material configured to provide a RADAR signature to a RADAR system.

32. The article of claim 29, wherein the pathway article comprises one or more signs having image data embodied thereon, the image data encoded with the code.

33. The article of claim 29, wherein the pathway article comprises a physical surface having an optical element embodied thereon, wherein the optical element embodies the code indicative of the temporary zone.

34. The article of claim 29, wherein the article further comprises an article message that includes a human-perceptible representation of pathway information for the vehicle pathway.

35-49. (canceled)
